(19) United States
(12) Patent Application Publication
(10) Pub. No.: US 2026/0303830 A1
(43) Pub. Date: Oct. 1, 2026

(54) Method and Apparatus of Explicit Mode Blending in Video Coding Systems

(71) Applicant: MEDIATEK INC., Hsinchu City (TW)

(72) Inventors: Hsin-Yi TSENG, Hsinchu City (TW); Man-Shu CHIANG, Hsinchu City (TW); Chih-Wei HSU, Hsinchu City (TW)

(21) Appl. No.: 18/880,334

(22) PCT Filed: Jun. 13, 2023
(86) PCT No.: PCT/CN2023/099802

§ 371 Date: Dec. 31, 2024

Related U.S. Application Data
(60) Provisional application No. 63/367,820, filed on Jul. 7, 2022.
(60) Provisional application No. 63/482,816, filed on Feb. 2, 2023.

(51) Int. Cl. H04N 19/159; H04N 19/176; H04N 19/186

(52) U.S. Cl. CPC H04N 19/159; H04N 19/176; H04N 19/186

(57) ABSTRACT

A method and apparatus for blending intra-prediction modes. According to the method for the decoder side, a first predictor is determined from a first intra-prediction candidate set, where the first predictor provides first prediction for the second-colour block. A second predictor is determined from a second intra-prediction candidate set, where the second predictor provides second prediction for the second-colour block. At least one of the first predictor and the second predictor is derived based on the first-colour block using a cross-component model. A final predictor is generated by blending the first predictor and the second predictor. The second-colour block is encoded or decoded by using prediction data comprising the final predictor.

### CROSS REFERENCE TO RELATED APPLICATIONS

The present invention is a non-Provisional Application of and claims priority to U.S. Provisional Patent Application No. 63/367,820, filed on Jul. 7, 2022 and U.S. Provisional Patent Application No. 63/482,816, filed on Feb. 2, 2023. The U.S. Provisional Patent Applications are hereby incorporated by reference in their entireties.

### FIELD OF THE INVENTION

The present invention relates to video coding system. In particular, the present invention relates to blending two intra-prediction modes and signalling coding modes and/or blending weight for improving coding performance.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. For example, to reduce the cross-component redundancy, a cross-component linear model (CCLM) prediction mode is used in the VVC, for which the chroma samples are predicted based on the reconstructed luma samples of the same CU by using a linear model. Furthermore, during the ongoing development of next generation video coding, more new coding tools, such as blending multiple prediction modes, have been disclosed. In the present invention, methods and apparatus for blending two intra-prediction modes, wherein at least one mode is related to cross-component prediction mode (for example, CCLM or any other type of cross-component prediction mode), are disclosed to improve the coding performance.

### BRIEF SUMMARY OF THE INVENTION

A method and apparatus for video coding are disclosed. According to the method, input data associated with a current block comprising a first-colour block and a second-colour block are received, wherein the input data comprise pixel data for the current block to be encoded at an encoder side or coded data associated with the current block to be decoded at a decoder side. A first predictor is determined from a first intra-prediction candidate set, wherein the first predictor provides first prediction for the second-colour block. A second predictor is determined from a second intra-prediction candidate set, wherein the second predictor provides second prediction for the second-colour block. At least one of the first predictor and the second predictor is derived based on the first-colour block using a cross-component model. A final predictor is generated by blending the first predictor and the second predictor. The second-colour block is encoded or decoded by using prediction data comprising the final predictor.

In one embodiment, the first-colour block corresponds to either a luma block or a chroma block and the second-colour block corresponds to one remaining colour-component block of the current block.

In one embodiment, the first intra-prediction candidate set or the second intra-prediction candidate set comprises one or more CCP (Cross Colour Prediction) modes, wherein said one or more CCP modes derive prediction for one colour-component block based on another colour-component block. In one embodiment, said one or more CCP modes comprise one or more CCLM types, one or more MMLM types, one or more GLM types, one or more CCCM types, or any combination thereof. The CCLM types may correspond to CCLM_LT, CCLM_L, CCLM_T, or any combination thereof. The MMLM types may correspond to MMLM_LT, MMLM_L, MMLM_T, or any combination thereof. The CCCM types may correspond to one CCCM model using a different convolutional filter shape, one CCCM model using non-down-sampled samples, one CCCM model with multiple down-sampling filters, one mixed CCCM model, one CCCM model derived with different numbers of reference lines, one CCCM model derived with templates at different locations, or any combination thereof.

In one embodiment, the second intra-prediction candidate set is generated from the first intra-prediction candidate set by excluding the first predictor.

In one embodiment, the first predictor or the second predictor is selected from the first intra-prediction candidate set or the second intra-prediction candidate set respectively based on TIMD costs associated with member candidates in the first intra-prediction candidate set or the second intra-prediction candidate set. In one embodiment, a target member candidate with a smallest TIMD cost is implicitly selected as the first predictor or the second predictor. In another embodiment, a list comprising k candidates with smallest TIMD costs is generated and an index is signalled in a bitstream or parsed from the bitstream to indicate the first predictor or the second predictor selected from the list, and wherein k is an integer smaller than a total number of candidates in the first intra-prediction candidate set or the second intra-prediction candidate set.

In one embodiment, the first predictor or the second predictor is selected from the first intra-prediction candidate set or the second intra-prediction candidate set respectively. The first predictor or the second predictor is determined according to an index signalled in a bitstream or parsed from the bitstream.

In one embodiment, a flag for the current block is signalled in a bitstream or parsed from the bitstream to indicate whether to determine the first predictor, the second predictor and the final predictor for the current block and whether to encode or decode the current block by using the prediction data comprising the final predictor. In one embodiment, the flag is signalled or parsed at a CU level, PU level or CTU level.

In one embodiment, the first intra-prediction candidate set consists of CCLM_LT, CCLM_L and CCLM_T, and the second intra-prediction candidate set consists of MMLM_LT, MMLM_L and MMLM_T.

In one embodiment, the final predictor corresponds to a weighted sum of the first predictor and the second predictor. In one example, weights for the weighted sum correspond to α and (1−α), where 0<α<1. In another example, weights for the weighted sum correspond to w₁ and w₂, and wherein w₁>0, w₂>0, and w₁+w₂=1. In one embodiment, the weights are determined based on first predictor TIMD cost and second predictor TIMD cost. In this case, w₁ can equal to (first predictor TIMD cost/(first predictor TIMD cost+second predictor TIMD cost)), and w₂ can be equal to (second predictor TIMD cost/(first predictor TIMD cost+second predictor TIMD cost)).

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 shows the 67 intra prediction modes as adopted by the VVC video coding standard.

FIGS. 3A-B illustrate examples of wide-angle intra prediction a block with width larger than height (FIG. 3A) and a block with height larger than width (FIG. 3B).

FIG. 4 shows an example of the location of the left and above samples and the sample of the current block involved in the LM_LA mode.

FIG. 5 shows an example of classifying the neighbouring samples into two groups according to multiple mode CCLM.

FIG. 6A illustrates an example of the CCLM model.

FIG. 6B illustrates an example of the effect of the slope adjustment parameter “u” for model update.

FIG. 7 illustrates an example of template-based intra mode derivation (TIMD) mode, where TIMD implicitly derives the intra prediction mode of a CU using a neighbouring template at both the encoder and decoder.

FIG. 8 illustrates an example of spatial part of the convolutional filter.

FIG. 9 illustrates an example of reference area with paddings used to derive the filter coefficients.

FIG. 10 illustrates the 16 gradient patterns for Gradient Linear Model (GLM).

FIG. 11 illustrates a flowchart of an exemplary video coding system that incorporates intra-prediction mode blending according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

Intra Mode Coding with 67 Intra Prediction Modes

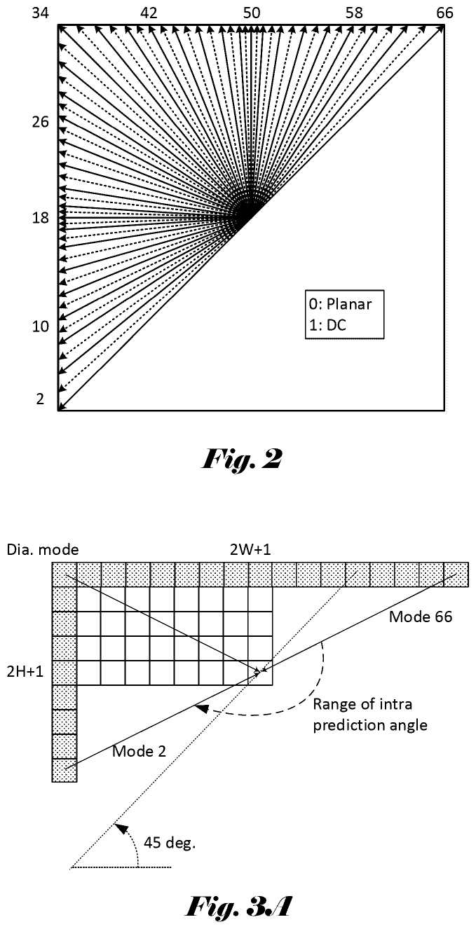

To capture the arbitrary edge directions presented in natural video, the number of directional intra modes in VVC is extended from 33, as used in HEVC, to 65. The new directional modes not in HEVC are depicted as dotted arrows in FIG. 2, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

To keep the complexity of the most probable mode (MPM) list generation low, an intra mode coding method with 6 MPMs is used by considering two available neighbouring intra modes. The following three aspects are considered to construct the MPM list:
Default intra modes
Neighbouring intra modes
Derived intra modes.

A unified 6-MPM list is used for intra blocks irrespective of whether MRL and ISP coding tools are applied or not. The MPM list is constructed based on intra modes of the left and above neighbouring block. Suppose the mode of the left is denoted as Left and the mode of the above block is denoted as Above, the unified MPM list is constructed as follows:
When a neighbouring block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, DC, Max−1, Max+1, Max−2}
If Left and Above are both angular and they are different:
   Set a mode Max as the larger mode in Left and Above
   if the difference of mode Left and Above is in the range of 2 to 62, inclusive
      MPM list→{Planar, Left, Above, DC, Max−1, Max+1} Otherwise.
      MPM list→{Planar, Left, Above, DC, Max−2, Max+2}
If Left and Above are both angular and they are the same:
   MPM list→{Planar, Left, Left−1, Left+1, DC, Left−2}

Besides, the first bin of the MPM index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

### Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

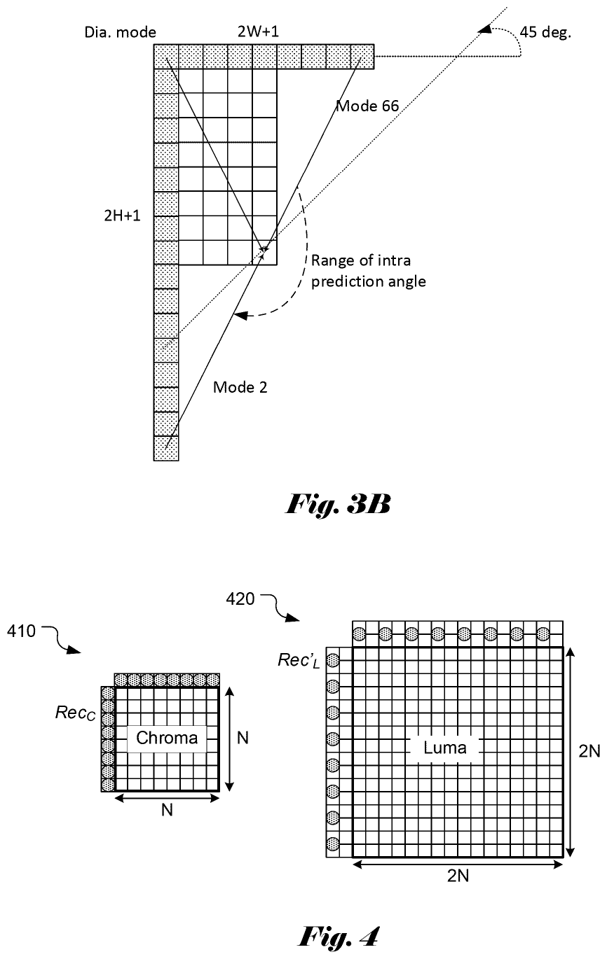

To support these prediction directions, the top reference with length 2W+1, and the left reference with length 2H+1, are defined as shown in FIG. 3A and FIG. 3B respectively.

The number of replaced modes in wide-angular direction mode depends on the aspect ratio of a block. The replaced intra prediction modes are illustrated in Table 1.

TABLE 1
Intra prediction modes replaced by wide-angular modes

| Aspect ratio | Replaced intra prediction modes |
|---|---|
| W/H == 16 | Modes 12, 13, 14, 15 |
| W/H == 8 | Modes 12, 13 |
| W/H == 4 | Modes 2, 3, 4, 5, 6, 7, 8, 9, 10, 11 |
| W/H == 2 | Modes 2, 3, 4, 5, 6, 7, |
| W/H == 1 | None |
| W/H == ½ | Modes 61, 62, 63, 64, 65, 66 |
| W/H == ¼ | Mode 57, 58, 59, 60, 61, 62, 63, 64, 65, 66 |
| W/H == ⅛ | Modes 55, 56 |
| W/H == 1/16 | Modes 53, 54, 55, 56 |

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135° and above 45°, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### Cross-Component Linear Model (CCLM) Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(i, j) represents the predicted chroma samples in a CU and rec_{L}(i, j) represents the downsampled reconstructed luma samples of the same CU.

The CCLM parameters (α and β) are derived with at most four neighbouring chroma samples and their corresponding down-sampled luma samples. Suppose the current chroma block dimensions are W×H, then W′ and H′ are set as
W′=W, H′=H when LM_LA mode is applied;
W′=W+H when LM_A mode is applied;
H′=H+W when LM_L mode is applied.

The above neighbouring positions are denoted as S[0, −1] . . . . S[W′−1, −1] and the left neighbouring positions are denoted as S[−1, 0] . . . . S[−1, H′−1]. Then the four samples are selected as
S[W′/4, −1], S[3*W′/4, −1], S[−1, H′/4], S[−1, 3*H′/4] when LM mode is applied and both above and left neighbouring samples are available;
S[W′/8, −1], S[3*W′/8, −1], S[5*W′/8, −1], S[7*W′/8, −1] when LM-A mode is applied or only the above neighbouring samples are available;
S[−1, H′/8], S[−1, 3*H′/8], S[−1, 5*H′/8], S[−1, 7*H′/8] when LM-L mode is applied or only the left neighbouring samples are available.

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

$$Xa = ( x 0 A + x 1 A + 1 ) ≫ 1 ; \qquad ( 2 )$$

$$Xb = ( x 0 B + x 1 B + 1 ) ≫ 1 ;$$

$$Ya = ( y 0 A + y 1 A + 1 ) ≫ 1 ;$$

$$Yb = ( y 0 B + y 1 B + 1 ) ≫ 1$$

Finally, the linear model parameters α and β are obtained according to the following equations.

$$α = \frac{{Y}_{a} - {Y}_{b}}{{X}_{a} - {X}_{b}} \qquad ( 3 )$$

$$β = {Y}_{b} - α \cdot {X}_{b} \qquad ( 4 )$$

FIG. 4 shows an example of the location of the left and above samples and the sample of the current block involved in the LM_LA mode. FIG. 4 shows the relative sample locations of N×N chroma block 410, the corresponding 2N×2N luma block 420 and their neighbouring samples (shown as filled circles).

The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 5 )$$

This would have a benefit of both reducing the complexity of the calculation as well as the memory size required for storing the needed tables.

Besides the above template and left template can be used to calculate the linear model coefficients together, they also can be used alternatively in the other 2 LM modes, called LM_A, and LM_L modes.

In LM_A mode, only the above template is used to calculate the linear model coefficients. To get more samples, the above template is extended to (W+H) samples. In LM_L mode, only left template are used to calculate the linear model coefficients. To get more samples, the left template is extended to (H+W) samples.

In LM_LA mode, left and above templates are used to calculate the linear model coefficients.

To match the chroma sample locations for 4:2:0 video sequences, two types of down-sampling filter are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$${Rec}_{L}^{′} ( i , j ) = [ {rec}_{L} ( 2 i - 1 , 2 j - 1 ) + 2 \cdot {rec}_{L} ( 2 i - 1 , 2 j - 1 ) + {rec}_{L} ( 2 i + 1 , 2 j - 1 ) + {rec}_{L} ( 2 i - 1 , 2 j ) + 2 \cdot {rec}_{L} ( 2 i , 2 j ) + {rec}_{L} ( 2 i + 1 , 2 j ) + 4 ] ≫ 3 \qquad ( 6 )$$

$${Rec}_{L}^{′} ( i , j ) = {rec}_{L} ( 2 i , 2 j - 1 ) + {rec}_{L} ( 2 i - 1 , 2 j ) + 4 \cdot {rec}_{L} ( 2 i , 2 j ) + {rec}_{L} ( 2 i + 1 , 2 j ) + {rec}_{L} ( 2 i , 2 j + 1 ) + 4 ] ≫ 3 \qquad ( 7 )$$

Note that only one luma line (general line buffer in intra prediction) is used to make the down-sampled luma samples when the upper reference line is at the CTU boundary. An exception happens if the top line of the current block is a CTU boundary. In this case, the one-dimensional filter [1, 2, 1]/4 is applied to the above neighboring luma samples in order to avoid the usage of more than one luma line above the CTU boundary.

This parameter computation is performed as part of the decoding process, and is not just as an encoder search operation. As a result, no syntax is used to convey the α and β values to the decoder.

For chroma intra mode coding, a total of 8 intra modes are allowed for chroma intra mode coding. Those modes include five traditional intra modes and three cross-component linear model modes ({LM_LA, LM_L, and LM_A}, or {CCLM_LT, CCLM_L, and CCLM_T}). The terms of {LM_LA, LM_L, LM_A} and {CCLM_LT, CCLM_L, CCLM_T} are used interchangeably in this disclosure. Chroma mode signalling and derivation process are shown in Table 2. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 2
Derivation of chroma prediction mode
from luma mode when CCLM is enabled

| Chroma | Corresponding luma intra prediction mode | | | | |
|---|---|---|---|---|---|
| prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 3.

TABLE 3
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 3, the first bin indicates whether it is regular (0) or CCLM modes (1). If it is LM mode, then the next bin indicates whether it is LM_LA (0) or not. If it is not LM_LA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 3 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### Multiple Model CCLM (MMLM)

In the JEM (J. Chen, E. Alshina, G. J. Sullivan, J.-R. Ohm, and J. Boyce, Algorithm Description of Joint Exploration Test Model 7, document JVET-G1001, ITU-T/ISO/IEC Joint Video Exploration Team (JVET), July 2017), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples.

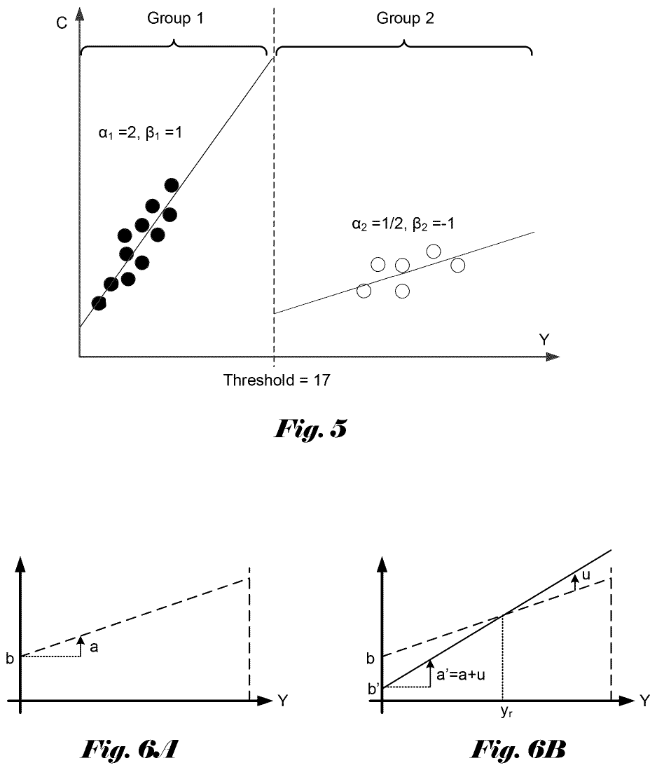

FIG. 5 shows an example of classifying the neighbouring samples into two groups. Threshold is calculated as the average value of the neighbouring reconstructed luma samples. A neighbouring sample with Rec′_{L}[x,y]<=Threshold is classified into group 1; while a neighbouring sample with Rec′_{L}[x,y]>Threshold is classified into group 2.

$$\{ \begin{matrix}{Pred}_{C} [ x , y ] = {α}_{1} \times {Rec}_{L}^{′} [ x , y ] + {β}_{1} & if {Rec}_{L}^{′} [ x , y ] \leq Threshold \\ {Pred}_{C} [ x , y ] = {α}_{2} \times {Rec}_{L}^{′} [ x , y ] + {β}_{2} & if {Rec}_{L}^{′} [ x , y ] > Threshold\end{matrix} \qquad ( 8 )$$

### Slope Adjustment of CCLM

CCLM uses a model with 2 parameters to map luma values to chroma values as shown in FIG. 6A. The slope parameter “a” and the bias parameter “b” define the mapping as follows:

$$chromaVal = a * lumaVal + b$$

An adjustment “u” to the slope parameter is signalled to update the model to the following form, as shown in FIG. 6B:

$$chromaVal = {a}^{′} * lumaVal + {b}^{′}$$

$$where$$

$${a}^{′} = a + u ,$$

$${b}^{′} = b - u * {y}_{r} .$$

With this selection, the mapping function is tilted or rotated around the point with luminance value yᵣ. The average of the reference luma samples used in the model creation as yᵣ in order to provide a meaningful modification to the model. FIGS. 6A and 6B illustrates the process.

### Implementation of Slope Adjustment of CCLM

Slope adjustment parameter is provided as an integer between −4 and 4, inclusive, and signalled in the bitstream. The unit of the slope adjustment parameter is (⅛)-th of a chroma sample value per luma sample value (for 10-bit content).

Adjustment is available for the CCLM models that are using reference samples both above and left of the block (e.g. “LM_CHROMA_IDX” and “MMLM_CHROMA_IDX”), but not for the “single side” modes. This selection is based on coding efficiency versus complexity trade-off considerations. “LM_CHROMA_IDX” and “MMLM_CHROMA_IDX” refers to CCLM_LT and MMLM_LT in this invention. The “single side” modes refers to CCLM_L, CCLM_T, MMLM_L, and MMLM_T in this invention.

When slope adjustment is applied for a multimode CCLM model, both models can be adjusted and thus up to two slope updates are signalled for a single chroma block.

### Encoder Approach for Slope Adjustment of CCLM

The proposed encoder approach performs an SATD (Sum of Absolute Transformed Differences) based search for the best value of the slope update for Cr and a similar SATD based search for Cb. If either one results as a non-zero slope adjustment parameter, the combined slope adjustment pair (SATD based update for Cr, SATD based update for Cb) is included in the list of RD (Rate-Distortion) checks for the TU.

### Multi-Hypothesis Prediction (MHP)

In the multi-hypothesis inter prediction mode (JVET-M0425), one or more additional motion-compensated prediction signals are signalled, in addition to the conventional bi-prediction signal. The resulting overall prediction signal is obtained by sample-wise weighted superposition. With the bi-prediction signal p_{bi} and the first additional inter prediction signal/hypothesis h₃, the resulting prediction signal p₃ is obtained as follows:

$${p}_{3} = ( 1 - α ) {p}_{b i} + α {h}_{3} \qquad ( 9 )$$

The weighting factor α is specified by the new syntax element add_hyp_weight_idx, according to the following mapping (Table 4):

TABLE 4
Mapping α to add_hyp_weight_idx

| add_hyp_weight_idx | α |
|---|---|
| 0 | ¼ |
| 1 | −⅛ |

Analogously to above, more than one additional prediction signal can be used. The resulting overall prediction signal is accumulated iteratively with each additional prediction signal.

$${P}_{n + 1} = {( 1 - {α}_{n + 1} )}_{{P}_{n}} + {α}_{n + 1} {h}_{n + 1} \qquad ( 10 )$$

The resulting overall prediction signal is obtained as the last pₙ (i.e., the pₙ having the largest index n). For example, up to two additional prediction signals can be used (i.e., n is limited to 2).

The motion parameters of each additional prediction hypothesis can be signalled either explicitly by specifying the reference index, the motion vector predictor index, and the motion vector difference, or implicitly by specifying a merge index. A separate multi-hypothesis merge flag distinguishes between these two signalling modes.

For inter AMVP mode, MHP is only applied if non-equal weight in BCW is selected in bi-prediction mode. Details of MHP for VVC can be found in JVET-W2025 (Muhammed Coban, et. al., “Algorithm description of Enhanced Compression Model 2 (ECM 2)”, Joint Video Experts Team (JVET) of ITU-T SG 16 WP 3 and ISO/IEC JTC 1/SC 29, 23rd Meeting, by teleconference, 7-16 Jul. 2021, Document: JVET-W2025).

### Template-Based Intra Mode Derivation (TIMD)

Template-based intra mode derivation (TIMD) mode implicitly derives the intra prediction mode of a CU using a neighbouring template at both the encoder and decoder, instead of signalling the intra prediction mode to the decoder. As shown in FIG. 7, the prediction samples of the template (712 and 714) for the current block 710 are generated using the reference samples (720 and 722) of the template for each candidate mode. A cost is calculated as the SATD (Sum of Absolute Transformed Differences) between the prediction samples and the reconstruction samples of the template. The intra prediction mode with the minimum cost is selected as the TIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode can be implicitly derived from the MPM list.

For each intra prediction mode in MPMs, the SATD between the prediction and reconstruction samples of the template is calculated. First two intra prediction modes with the minimum SATD are selected as the TIMD modes. These two TIMD modes are fused with weights after applying PDPC process, and such weighted intra prediction is used to code the current CU. Position dependent intra prediction combination (PDPC) is included in the derivation of the TIMD modes.

The costs of the two selected modes are compared with a threshold, in the test, the cost factor of 2 is applied as follows:

$$costMode 2 < 2 * costMode 1.$$

If this condition is true, the fusion is applied, otherwise only model is used. Weights of the modes are computed from their SATD costs as follows:

$$weight 1 = costMode 2 / ( costMode 1 + costMode 2 )$$

$$weight 2 = 1 - weight 1.$$

### Fusion of Chroma Intra Prediction Modes

During the development of emerging video coding system, it has been proposed that the DM mode and four default modes can be fused with the MMLM_LT mode as follows:

$$pred = ( w 0 * pred 0 + w 1 * pred 1 + ( 1 << ( shift - 1 ) ) ) >> \text{shift.}$$

In the above equation, pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w₁}={3, 1}; otherwise, {w0,w1}={2, 2}.

For the syntax design, if a non-LM mode is selected, one flag is signalled to indicate whether the fusion is applied. And the proposed fusion is only applied to I slices.

### Convolutional Cross-Component Model (CCCM)

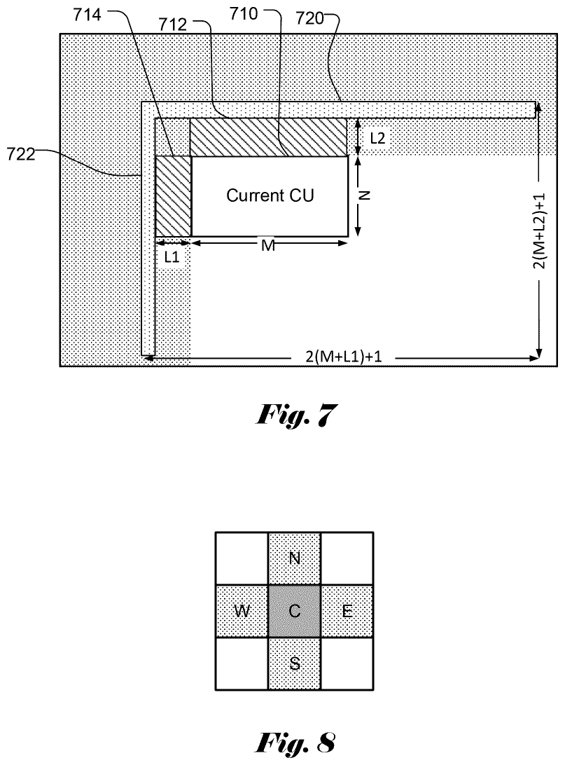

In CCCM, a convolutional model is applied to improve the chroma prediction performance. The convolutional model has 7-tap filter consisting of a 5-tap plus sign shape spatial component, a nonlinear term and a bias term. The input to the spatial 5-tap component of the filter consists of a center (C) luma sample which is collocated with the chroma sample to be predicted and its above/north (N), below/south(S), left/west (W) and right/east (E) neighbours as shown in FIG. 8.

The nonlinear term (denoted as P) is represented as power of two of the center luma sample C and scaled to the sample value range of the content:

$$P = ( C * C + midVal ) >> bitDepth .$$

For example, for 10-bit contents, the nonlinear term is calculated as:

$$P = ( C * C + 5 \; 12 ) >> 10$$

The bias term (denoted as B) represents a scalar offset between the input and output (similarly to the offset term in CCLM) and is set to the middle chroma value (512 for 10-bit content).

Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

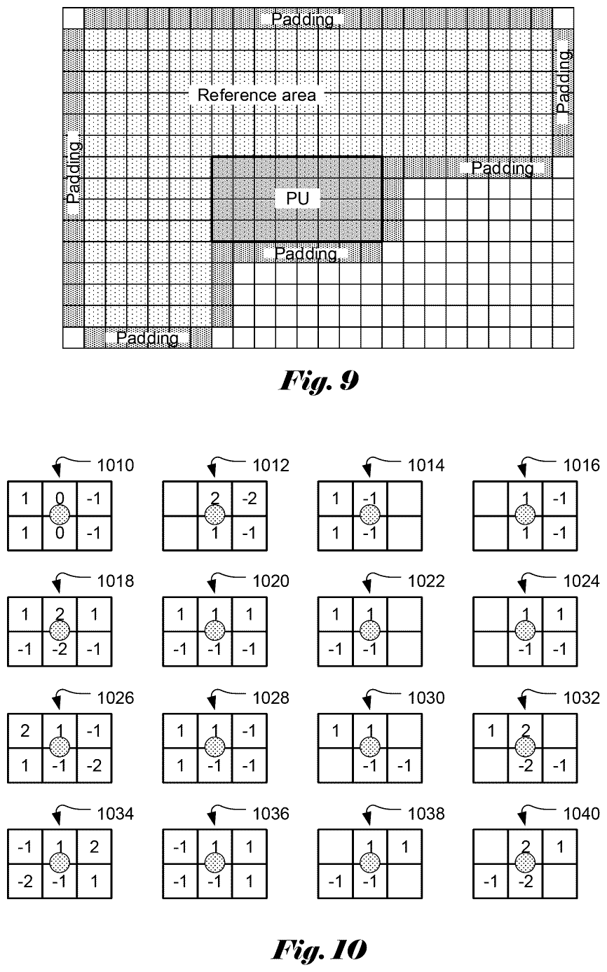

The filter coefficients ci are calculated by minimising MSE between predicted and reconstructed chroma samples in the reference area. FIG. 9 illustrates an example of the reference area which consists of 6 lines of chroma samples above and left of the PU 910. Reference area extends one PU width to the right and one PU height below the PU boundaries. Area is adjusted to include only available samples. The extensions to the area (indicated as “paddings”) are needed to support the “side samples” of the plus-shaped spatial filter in FIG. 8 and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

### Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

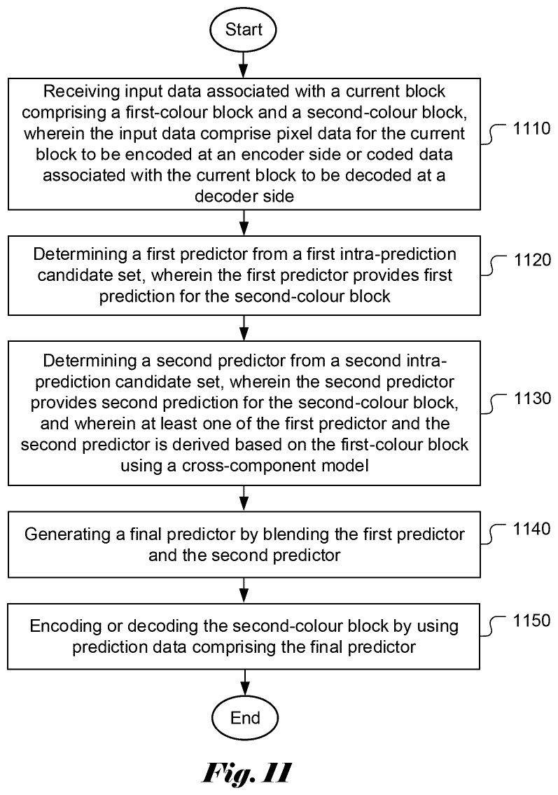

For signalling, when the CCLM mode is enabled for the current CU, two flags are signalled separately for Cb and Cr components to indicate whether GLM is enabled for each component. If the GLM is enabled for one component, one syntax element is further signalled to select one of 16 gradient filters (1010-1040 in FIG. 10) for the gradient calculation. The GLM can be combined with the existing CCLM by signalling one extra flag in bitstream. When such combination is applied, the filter coefficients that are used to derive the input luma samples of the linear model are calculated as the combination of the selected gradient filter of the GLM and the down-sampling filter of the CCLM.

### Proposed Method

In order to improve video coding efficiency, some coding tools are disclosed for more efficient signalling and/or to generate better predictors. With the traditional mechanism, an inter mode utilizes temporal information to predict the current block. For an intra block, spatially neighbouring reference samples are used to predict the current block. In this invention, a coding tool is proposed. The coding tool creates a new blending mode to form a better predictor and more efficient signalling. The concept of this coding tool is described as follows.

In one embodiment, an additional hypothesis of intra prediction (denoted as H2) is blended with the existing hypothesis of intra prediction (denoted as H1) by a pre-defined weighting to form the final prediction of the current block. H1 is generated by one mode selected from the first mode set (denoted as Set1), and H2 is generated by one mode selected from the second mode set (denoted as Set2). Let the weighting to blend H1 and H2 be w1 and w2,

$$Final prediction = {w}_{1} * {H}_{1} + {w}_{2} * {H}_{2} ,$$

where H1 and H2 can be any intra modes. Intra modes refer modes used to generate intra block predictions. For example, the 67 intra prediction modes, the CCLM modes and the MMLM modes mentioned earlier.

In another embodiment, H1 and H2 can be any cross-component prediction modes. Cross-component prediction modes refer to modes that predict the second colour component of a block by the first colour component of a block with a model describing the relationship of the two colour components. For example, the first colour component can be luma component, and the second colour component can be Cb or Cr. For another example, the first colour component can be Cb and the second colour component can be Cr. The model can be a linear model, a convolutional model or a mapping model. Examples of cross-component prediction modes includes CCLM, MMLM, GLM, CCCM and variants of CCCM. CCLM and MMLM predict chroma components by the luma component using a linear model. While CCCM predicts chroma components by the luma component using a convolutional model. A mapping models comprises lookup tables, in which the first colour component value and the second colour component value mapping relationship is recorded. The first colour component values (e.g., sample intensity) are the indexes of the lookup tables. To predict the second colour component sample value in the current block, the collocated first colour component sample value is looked up in the lookup tables and the corresponding second colour component values in the tables are used to predict the second colour component sample value in the current block.

In another embodiment, H1 and H2 can be any convolutional cross-component model modes (CCCM) and CCCM variants. For example, CCCM model using different convolutional filter shape, CCCM model using non-downsampled samples, CCCM model with multiple down-sampling filters, mixed CCCM model with various terms (e.g. spatial term, gradient term, location term, non-linear term and bias term), CCCM model derived with different number of reference lines, and CCCM model derived with templates at different locations. All the CCCM modes mentioned in this paragraphs are referred as CCCM types in this disclosure.

In another embodiment, H1 and H2 can be any LM modes. LM modes refer to modes that predict chroma component of a block by the collocated reconstructed luma samples according to linear models, whose parameters are derived from already reconstructed luma and chroma samples that are adjacent to the block. LM modes includes CCLM and MMLM.

In another embodiment, H1 and H2 can be any LM modes and GLM modes.

In another embodiment, H1 can be any CCLM mode and H2 can be any MMLM modes

In one embodiment, this coding tool is applied to blocks of any colour component. For example, it can be applied to luma component and/or chroma components.

In another embodiment, this coding tool is applied to blocks of chroma components.

In one embodiment, a flag is signalled/parsed at block-level to indicate whether to apply the blending mode to the current block. For example, the flag can be signalled at CU level and/or PU level and/or CTU level. For another example, the flag can be signal at CB level and/or PB level and/or CTB and/or TU/TB and/or any predefined region level.

In one embodiment, when the flag indicates that the blending mode is disabled, the original syntax for signalling/parsing an intra prediction mode for the current block is followed. When the flag indicates that the blending mode is enabled, the following syntax related to indicating the modes to generated H1 and H2 and/or weighting is needed to be decided and signalled at encoder or parsed at decoder.

In one sub-embodiment, the blending mode and other intra prediction modes, indicated by original syntax, are mutually exclusive, i.e., if blending mode is chosen, other intra prediction modes cannot be chosen, and vice versa. Only the syntax related to blending mode is signalled.

In one sub-embodiment, the blending mode and other intra prediction modes, indicated by original syntax, are not mutually exclusive. The original syntax is then sent after the syntax related to blending mode. For example, another hypothesis H3, generated by the mode indicated by the original syntax, can be further blended with H1 and H2 by another pre-defined weighting to generate a block predictor. The original syntax can also be sent before the syntax related to the blending mode. For example, when the fusion of chroma intra prediction flag is on, the DM mode and the four default modes can be fused with the blending mode, instead of MMLM_LT if blending mode is also enabled.

In one embodiment, a flag is signalled after the flag enabling/disabling LM modes. For example, the flag is signalled after CclmEnabled flag. CclmEnabled specifies if a cross-component chroma intra prediction mode is enabled (i.e., TRUE) or not enabled (i.e., FALSE) for the current chroma coding block.

For another embodiment, the flag is signalled before the flag enabling/disabling LM modes. For example, the flag is signalled before CclmEnabled flag. CclmEnabled specifies if a cross-component chroma intra prediction mode is enabled (i.e., TRUE) or not enabled (i.e., FALSE) for the current chroma coding block.

For another embodiment, the flag is signalled after the flag specifying if the decoded residuals of the current coding unit are applied using a colour space conversion. For example, the flag is signalled after cu_act_enabled_flag. cu_act_enabled_flag equal to 1 specifies that the decoded residuals of the current coding unit are applied using a colour space conversion. cu_act_enabled_flag equal to 0 specifies that the decoded residuals of the current coding unit are applied without a colour space conversion. When cu_act_enabled_flag is not present, it is inferred to be equal to 0.

As mentioned earlier, H1 is generated by one mode selected from the first mode set (denoted as Set1), and H2 is generated by one mode selected from the second mode set (denoted as Set2). H1 and H2 can be any intra modes. In one embodiment, Set1 includes CCLM_LT, CCLM_L, CCLM_T, MMLM_LT, MMLM_L, MMLM_T, or any subset of the above modes, or any extension of LM family.

In another embodiment, Set1 includes CCLM_LT, CCLM_L, CCLM_T, or any subset of the above modes. The CCLM_LT, CCLM_L, CCLM_T are referred as CCLM types in this disclosure.

In another embodiment, Set1 includes MMLM_LT, MMLM_L, MMLM_T, or any subset of the above modes. The MMLM_LT, MMLM_L, MMLM_T are referred as MMLM types in this disclosure.

In one embodiment, Set2 includes CCLM_LT, CCLM_L, CCLM_T, MMLM_LT, MMLM_L, MMLM_T, or any subset of the above modes, or any extension of LM family.

In another embodiment, Set2 includes CCLM_LT, CCLM_L, CCLM_T, or any subset of the above modes.

In another embodiment, Set2 includes MMLM_LT, MMLM_L, MMLM_T, or any subset of the above modes. The MMLM_LT, MMLM_L, MMLM_T are referred as MMLM types in this disclosure.

In one embodiment, the number of candidates in Set2 is less than the number of candidates in Set1.

In one sub-embodiment, Set2 is generated from Set1 by excluding the mode selected for generating H1. The number of candidates in Set2 is one less than the number of candidates in Set1.

In another sub-embodiment, when the weighting used in blending is implicitly decided, (e.g., if equal weighting is used), the size of Set2 can be further reduced. For example, if Set1 contains CCLM_LT, CCLM_L, CCLM_T, MMLM_LT, MMLM_L, and MMLM_T.
If CCLM_LT is used to generate H1, Set2 includes CCLM_L, CCLM_T, MMLM_LT, MMLM_L, and MMLM_T.
If CCLM_L is used to generate H1, Set2 includes CCLM_T, MMLM_LT, MMLM_L, and MMLM_T.
If CCLM_T is used to generate H1, Set2 includes MMLM_LT, MMLM_L, and MMLM_T.
If MMLM_LT is used to generate H1, Set2 includes MMLM_L and MMLM_T.
If MMLM_L is used to generate H1, Set2 includes MMLM_T.

In one embodiment, the mode selected from Set1 to generate H1 is indicated by an index (denoted as index0) which is signalled/parsed in the bitstream. The mode selected from Set2 to generate H2 is indicated by an index (denoted as index1) which signalled/parsed in the bitstream.

In one sub-embodiment, let the number of candidates in Set1 is N1, Index0 ranges from 0 to N1 minus 1.

In one sub-embodiment, Index0 is context coded. The context is decided by information from neighbouring blocks. It can be determined based on the neighbouring mode information. For example, we select one context if more neighbouring blocks are CCLM modes (e.g. CCLM_LT, CCLM_L, CCLM_T), and another context if more neighbouring blocks are MMLM mode (e.g. MMLM_LT, MMLM_L, MMLM_T). For another example, we select one context if more neighbouring blocks are LT modes (e.g. CCLM_LT, MMLM_LT), another context if more neighbouring blocks are L modes (e.g. CCLM_L, MMLM_L), and another context if more neighbouring blocks are T modes (e.g. CCLM_T, MMLM_T).

In another sub-embodiment, Index0 is truncated unary coded. For example, if Set1 contains CCLM_LT, CCLM_L, CCLM_T, MMLM_LT, MMLM_L, and MMLM_T, and if the frequency the modes are signalled with are also in this order (i.e., CCLM_LT the most frequently signalled and MMLM_T the least frequently signalled), the truncated unary code used can be designed as shown in Table 5:

TABLE 5
An example of truncated unary code for Index0.

| CCLM_{—} | CCLM_{—} | CCLM_{—} | MMLM_{—} | MMLM_{—} | MMLM_{—} |
|---|---|---|---|---|---|
| LT | L | T | LT | L | T |
| 0 | 10 | 110 | 1110 | 11110 | 11111 |

In one sub-embodiment, if the number of candidates in Set2 is N2, Index1 ranges from 0 to N2 minus 1.

In one sub-embodiment, Index1 is context coded. The context is decided by information from neighbouring blocks. It can be determined based on the neighbouring mode information. For example, we select one context if more neighbouring blocks are CCLM modes (e.g. CCLM_LT, CCLM_L, CCLM_T), and another context if more neighbouring blocks are MMLM mode (MMLM_LT, MMLM_L, MMLM_T). For another example, we select one context if more neighbouring blocks are LT modes (e.g. CCLM_LT, MMLM_LT), another context if more neighbouring blocks are L modes (e.g. CCLM_L, MMLM_L), and another context if more neighbouring blocks are T modes (e.g. CCLM_T, MMLM_T).

In another sub-embodiment, Index1 is truncated unary coded. For example, if Set2 contains CCLM_L, CCLM_T, MMLM_LT, and MMLM_L, and MMLM_T, and if the frequency the modes are signalled with are also in this order (CCLM is the most frequently signalled and MMLM_T is the least frequently signalled), the truncated unary code used can be designed as shown in Table 6:

TABLE 6
An example of truncated unary code for Index1.

| CCLM_L | CCLM_T | MMLM_LT | MMLM_L | MMLM_T |
|---|---|---|---|---|
| 0 | 10 | 110 | 1110 | 1111 |

In one embodiment, since the number of candidates in Set2 is less than the number of candidates in Set1, and with the aforementioned embodiments regarding the coding of index0 and index1, codewords for Index1 are shorter than codewords for index0. For example, let Set1 contains CCLM_LT, CCLM_L, CCLM_T, MMLM_LT, MMLM_L, and MMLM_T, truncated unary code is used for both Index0 and Index1, and CCLM_LT is selected to generate H1.

An example of the truncated unary code for Index0 is shown in Table 7:

TABLE 7
An example of truncated unary code for Index0.

| CCLM_{—} | CCLM_{—} | CCLM_{—} | MMLM_{—} | MMLM_{—} | MMLM_{—} |
|---|---|---|---|---|---|
| LT | L | T | LT | L | T |
| 0 | 10 | 110 | 1110 | 11110 | 11111 |

An example of the truncated unary code for Index1 is shown in Table 8:

TABLE 8
An example of truncated unary code for Index1.

| CCLM_L | CCLM_T | MMLM_LT | MMLM_L | MMLM_T |
|---|---|---|---|---|
| 0 | 10 | 110 | 1110 | 1111 |

Six different codewords are needed to signal Index0 and the maximum length of codewords for Index0 is 5. While only 5 different codewords are needed to signal Index1 and the maximum length of codewords for Index1 is 4.

In another embodiment, the modes selected to generate H1 and H2 is indicated by a joint index (denoted as index2) which is signalled/parsed in the bitstream.

In one sub-embodiment, let N3 denote the number of different mode combinations that can be used to generate H1 and H2, i.e., all the different mode combinations selected from Set1 and Set2. The Index2 ranges from 0 to N3 minus 1. For example, let Set 1 contains CCLM_LT, CCLM_L, CCLM_T, MMLM_LT, MMLM_L, and MMLM_T. N3 equals 15 and all the different combinations are:
(CCLM_LT, CCLM_L), (CCLM_LT, CCLM_T), (CCLM_LT, MMLM_LT), (CCLM_LT, MMLM_L), and (CCLM_LT, MMLM_T).
(CCLM_L, CCLM_T), (CCLM_L, MMLM_LT), (CCLM_L, MMLM_L), and (CCLM_L, MMLM_T).
(CCLM_T, MMLM_LT), (CCLM_T, MMLM_L), and (CCLM_T, MMLM_T).
(MMLM_LT, MMLM_L) and (MMLM_LT, MMLM_T).
(MMLM_L, MMLM_T).

In one sub-embodiment, Index2 is context coded. The context is decided by information from neighbouring blocks. It can be determined based on the neighbouring mode information. For example, we select one context if more neighbouring blocks are CCLM modes (CCLM_LT, CCLM_L, CCLM_T), and another context if more neighbouring blocks are MMLM mode (MMLM_LT, MMLM_L, MMLM_T). For another example, we select one context if more neighbouring blocks are LT modes (CCLM_LT, MMLM_LT), another context if more neighbouring blocks are L modes (CCLM_L, MMLM_L), and another context if more neighbouring blocks are T modes (CCLM_T, MMLM_T).

In another sub-embodiment, Index2 is truncated unary coded. For example, let Set1 contains CCLM_LT, CCLM_L, CCLM_T, MMLM_LT, MMLM_L, and MMLM_T. N3 equals 15. Let the mode combinations be listed in the descending order of how frequently this mode combination is being signalled: (CCLM_LT, CCLM_L), (CCLM_LT, CCLM_T), (CCLM_LT, MMLM_LT), (CCLM_LT, MMLM_L), (CCLM_LT, MMLM_T), . . . , (MMLM_L, MMLM_T). The truncated unary code used can be designed as shown in Table 9:

TABLE 9
An example of truncated unary code for Index2.

| CCLM_LT, | CCLM_LT, | CCLM_LT, | CCLM_LT, | CCLM_LT, | | MMLM_L, |
|---|---|---|---|---|---|---|
| CCLM_L | CCLM_T | MMLM_LT | MMLM_L | MMLM_T | | MMLM_T |
| 0 | 10 | 110 | 1110 | 11110 | . . . | 11111111111111 |

In one embodiment, the weighting to combine H1 and H2 is indicated by an index (denoted as index3) which is signalled or parsed in the bitstream. Index3 indicates a candidate from a weight set. For example, the weight set (wₕ₁, wₕ₂) can be MHP-like weights, where wₕ₁=(1−α), wₕ₂=α, and α=¼ or −⅛,

$$final predictor = ( 1 - α ) {h}_{1} + α {h}_{2} .$$

For another example, the weight set (wₕ₁, wₕ₂) can also be (3, 5), (5, 3), (−2, 10), (10, −2), (4, 4), or any subset of the above weights.

In another embodiment, the weighting is implicitly decided. For example, the weighting can be inferred as equal weighting.

In one sub-embodiment, the weighting can be decided based on the block size. For example, the weighting used is determined based on whether the block width or height is greater than a pre-determined value. The value can be 2, 4, 8, 16 or any other allowed value for block width/height. For another example, the weighting used is determined based on whether the block area is greater than a pre-determine value. The value can be 4*4, 8*8 or other allowed sizes for block area.

In another sub-embodiment, the weighting is decided by mode information from neighbouring blocks. For example, if H1 is LT mode (CCLM_LT and MMLM_LT) and H2 is not a LT mode, and more neighbouring blocks are LT modes, then H1 has larger weight. For another example, if H1 is CCLM mode (e.g. CCLM_LT, CCLM_L, CCLM_T) and H2 is MMLM mode (e.g. MMLM_LT, MMLM_L, MMLM_T), and more neighbouring blocks are CCLM mode, then H1 has larger weight.

In another sub-embodiment, the weighting is decided by the TIMD cost. TIMD cost is defined as follows. For each mode, as shown in FIG. 7, the prediction samples of the template are generated using the reference samples of the template. For the case of CCP modes, the CCP model is derived based on the reconstruction samples on the reference lines. The number of reference lines can be more than 1. The prediction samples of the second colour component of the template are generated based on the first colour component samples of the template using the derived CCP model. Take CCLM modes as examples. A CCLM_LT model can be derived using the reconstructed luma and chroma samples on the top and left reference lines, a CCLM_L model can be derived using the reconstructed luma and chroma samples on the left reference lines, and a CCLM_T model can be derived using the reconstructed luma and chroma samples on the top reference lines. The prediction chroma samples of the templates are then generated based on the reconstructed luma samples of the template using the derived linear model. TIMD cost is calculated as the difference between the prediction and the reconstruction samples of the template. The difference can be SATD, SAD (Sum of Absolute Difference), a weighted sum of SATD and SAD, or other difference measures. TIMD cost can be determined at the decoder and does not need to be signalled. For example, if the mode for generating H1 has a larger TIMD cost, H1 uses a smaller weight during blending. If the mode for generating H2 has a larger TIMD cost, H2 uses a smaller weight during blending. For another example,

$${w}_{h 1} = {TIMD\_cost}_{h 2} / ( {TIMD\_cost}_{h 1} + {TIMD\_cost}_{h 2} ) )$$

$${w}_{h 2} = {TIMD\_cost}_{h 1} / ( {TIMD\_cost}_{h 1} + {TIMD\_cost}_{h 2} ) )$$

In another sub-embodiment, if the mode for generating H1 has a much larger TIMD cost than H2, only H2 is used to form the final prediction.

In another sub-embodiment, if the mode for generating H2 has a much larger TIMD cost than H1, only H1 is used to form the final prediction.

In another sub-embodiment, if the mode for generating H1 has a much larger TIMD cost than H2, H1 is changed to be generated by a pre-defined intra mode.

In another sub-embodiment, if the mode for generating H2 has a much larger TIMD cost than H1, H2 is changed to be generated by a pre-defined intra mode.

In one embodiment, when Set1, Set2, or the weight set includes only one candidate, the only one candidate is inferred to be used.

In one embodiment, the modes selected to generate H1 and H2 are explicitly signalled, and the weighting to combine two modes is implicitly decided. For example, the method to signal the modes selected can be separately signalling two modes, by signalling Index0 and Index1. The method can also be jointly signalling two modes together, by signalling Index2. The weighting is implicitly decided by TIMD cost.

$${w}_{h 1} = {TIMD\_cost}_{h 2} / ( {TIMD\_cost}_{h 1} + {TIMD\_cost}_{h 2} ) )$$

$${w}_{h 2} = {TIMD\_cost}_{h 1} / ( {TIMD\_cost}_{h 1} + {TIMD\_cost}_{h 2} ) )$$

In one embodiment, a flag is signalled/parsed at block-level to indicate whether to apply the blending mode to the current block. The modes selected to generate H1 and H2 are implicitly decided, and the weighting to combine two modes is implicitly decided. For example, the modes are implicitly decided by the TIMD cost. The two modes with the lowest TIMD costs are selected. For another example, if the TIMD cost of one mode selected is much larger than the TIMD cost of another mode selected, only the mode with smaller TIMD cost is used to form the final prediction. For example, if the template above current CU and the template on the left side of current CU (as depicted in FIG. 7) are both available, two default modes (e.g. CCLM_LT, CCLM_L) are selected. For example, if the template above current CU is not available and the template on the left side of current CU is available, two default modes (e.g. CCLM_L, MMLM_L) are selected. For example, if the template above current CU is available and the template on the left side of current CU is not available, two default modes (e.g. CCLM_T, MMLM_T) are selected. For example, the weighting is implicitly decided by TIMD cost.

$${w}_{h 1} = {TIMD\_cost}_{h 2} / ( {TIMD\_cost}_{h 1} + {TIMD\_cost}_{h 2} ) )$$

$${w}_{h 2} = {TIMD\_cost}_{h 1} / ( {TIMD\_cost}_{h 1} + {TIMD\_cost}_{h 2} ) )$$

In one embodiment, the modes selected to generate H1 and H2 are implicitly decided. When the template above current CU and the template on the left side of current CU (as depicted in FIG. 7) are both unavailable, the blending mode is disabled.

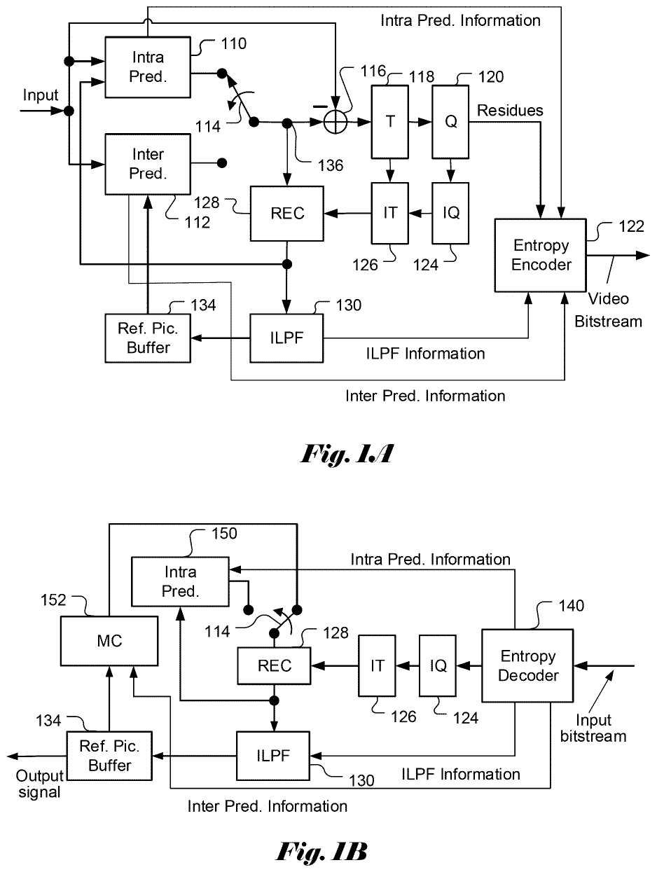

The intra-prediction mode blending method as described above can be implemented in an encoder side or a decoder side. For example, any of the proposed mode blending method can be implemented in an Intra coding module (e.g. Intra pred. 150 in FIG. 1B) in a decoder or an Intra coding module is an encoder (e.g. Intra Pred. 110 in FIG. 1A). Any of the proposed cross-component prediction mode (for, example, CCLM or any other type of cross-component prediction mode) methods can also be implemented as a circuit coupled to the intra coding module at the decoder or the encoder. However, the decoder or encoder may also use additional processing unit to implement the required mode blending method. While the Intra Pred. units (e.g. unit 110 in FIG. 1A and unit 150 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 11 illustrates a flowchart of an exemplary video coding system that incorporates a intra-prediction blending method according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block comprising a first-colour block and a second-colour block are received in step 1110, wherein the input data comprise pixel data for the current block to be encoded at an encoder side or coded data associated with the current block to be decoded at a decoder side. A first predictor is determined from a first intra-prediction candidate set in step 1120, wherein the first predictor provides first prediction for the second-colour block. A second predictor is determined from a second intra-prediction candidate set in step 1130, wherein the second predictor provides second prediction for the second-colour block, and wherein at least one of the first predictor and the second predictor is derived based on the first-colour block using a cross-component model. A final predictor is generated in step 1140 by blending the first predictor and the second predictor. The second-colour block is encoded or decoded by using prediction data comprising the final predictor in step 1150.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding for colour pictures, the method comprising:
receiving input data associated with a current block comprising a first-colour block and a second-colour block, wherein the input data comprise pixel data for the current block to be encoded at an encoder side or coded data associated with the current block to be decoded at a decoder side;
determining a first predictor from a first intra-prediction candidate set, wherein the first predictor provides first prediction for the second-colour block;
determining a second predictor from a second intra-prediction candidate set, wherein the second predictor provides second prediction for the second-colour block, and wherein at least one of the first predictor and the second predictor is derived based on the first-colour block using a cross-component model;
generating a final predictor by blending the first predictor and the second predictor; and
encoding or decoding the second-colour block by using prediction data comprising the final predictor.

2. The method of claim 1, wherein the first-colour block corresponds to either a luma block or a chroma block and the second-colour block corresponds to one remaining colour-component block of the current block.

3. The method of claim 1, wherein the first intra-prediction candidate set or the second intra-prediction candidate set comprises one or more CCP (Cross Colour Prediction) modes, wherein said one or more CCP modes derive prediction for one colour-component block based on another colour-component block.

4. The method of claim 3, wherein said one or more CCP modes comprise one or more CCLM types, one or more MMLM types, one or more GLM types, one or more CCCM types, or any combination thereof.

5. The method of claim 4, wherein said one or more CCLM types correspond to CCLM_LT, CCLM_L, CCLM_T, or any combination thereof.

6. The method of claim 4, wherein said one or more MMLM types correspond to MMLM_LT, MMLM_L, MMLM_T, or any combination thereof.

7. The method of claim 4, wherein said one or more CCCM types correspond to one CCCM model using a different convolutional filter shape, one CCCM model using non-down-sampled samples, one CCCM model with multiple down-sampling filters, one mixed CCCM model, one CCCM model derived with different numbers of reference lines, one CCCM model derived with templates at different locations, or any combination thereof.

8. The method of claim 1, wherein the second intra-prediction candidate set is generated from the first intra-prediction candidate set by excluding the first predictor.

9. The method of claim 1, wherein the first predictor or the second predictor is selected from the first intra-prediction candidate set or the second intra-prediction candidate set respectively based on TIMD costs associated with member candidates in the first intra-prediction candidate set or the second intra-prediction candidate set.

10. The method of claim 9, wherein a target member candidate with a smallest TIMD cost is implicitly selected as the first predictor or the second predictor.

11. The method of claim 9, wherein a list comprising k candidates with smallest TIMD costs is generated and an index is signalled in a bitstream or parsed from the bitstream to indicate the first predictor or the second predictor selected from the list, and wherein k is an integer smaller than a total number of candidates in the first intra-prediction candidate set or the second intra-prediction candidate set.

12. The method of claim 1, wherein the first predictor or the second predictor is determined according to an index signalled in a bitstream or parsed from the bitstream.

13. The method of claim 1, wherein a flag for the current block is signalled in a bitstream or parsed from the bitstream to indicate whether to determine the first predictor, the second predictor and the final predictor for the current block and whether to encode or decode the current block by using the prediction data comprising the final predictor.

14. The method of claim 13, wherein the flag is signalled or parsed at a CU level, PU level or CTU level.

15. The method of claim 1, wherein the first intra-prediction candidate set consists of CCLM_LT, CCLM_L and CCLM_T, and the second intra-prediction candidate set consists of MMLM_LT, MMLM_L and MMLM_T.

16. The method of claim 1, wherein the final predictor corresponds to a weighted sum of the first predictor and the second predictor.

17. The method of claim 16, wherein weights for the weighted sum correspond to α and (1-a), and wherein 0<α<1.

18. The method of claim 16, wherein weights for the weighted sum correspond to w₁ and w₂, and wherein w₁>0, w₂>0, and w₁+w₂=1.

19. The method of claim 18, wherein the weights are determined based on first predictor TIMD cost and second predictor TIMD cost.

20. The method of claim 19, wherein w₁ is equal to (first predictor TIMD cost/(first predictor TIMD cost+second predictor TIMD cost)), and w₂ is equal to (second predictor TIMD cost/(first predictor TIMD cost+second predictor TIMD cost)).

21. An apparatus for video coding, the apparatus comprising one or more electronics or processors arranged to:
receive input data associated with a current block comprising a first-colour block and a second-colour block, wherein the input data comprise pixel data for the current block to be encoded at an encoder side or coded data associated with the current block to be decoded at a decoder side;
determine a first predictor from a first intra-prediction candidate set, wherein the first predictor provides first prediction for the second-colour block;
determine a second predictor from a second intra-prediction candidate set, wherein the second predictor provides second prediction for the second-colour block, and wherein at least one of the first predictor and the second predictor is derived based on the first-colour block using a cross-component model;
generate a final predictor by blending the first predictor and the second predictor; and
encode or decode the second-colour block by using prediction data comprising the final predictor.
